(19) United States
(12) Patent Application Publication
(10) Pub. No.: US 2008/0020185 A1
(43) Pub. Date: Jan. 24, 2008

(54) Manufacturing method for base plate for use in disk drive, base plate for use in disk drive, and disk drive

(75) Inventors: Rico Macatangay, Minami-ku (JP); Dondi Perez, Minami-ku (JP); Takashi Fujiwara, Minami-ku (JP); Tomoaki Hayase, Minami-ku (JP); Takahiro Nakamura, Mimami-ku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIDEC CORPORATION, Minami-ku (JP)

(21) Appl. No.: 11/711,064

(22) Filed: Feb. 27, 2007

(30) Foreign Application Priority Data
Jul. 24, 2006 (JP) 2006-200278

(51) Int. Cl. B32B 3/00; B28B 7/14

(52) U.S. Cl. 428/161; 264/163

(57) ABSTRACT

A manufacturing method for a base plate for use in a disk drive is provided. The base plate includes a first face and a second face that are opposed to each other. The first face includes a concave portion formed thereon for accommodating a disk-shaped storage medium. During manufacturing of the base plate, a cutting process is performed for the unfinished base plate so as to remove a raised portion at a position at which a bottom face of the concave portion and a wall standing from the bottom face are connected to each other. In this manner, the base plate in which raised portion remains at the position at which the bottom face and the wall are connected to each other is obtained.

### BACKGROUND OF THE INVENTION

1. Field of the Invention

The present invention relates to a method of a base plate for use in a disk drive such as a hard disk drive or a magnetic disk drive, and also relates to a base plate and a disk drive which include that base plate.

2. Description of the Related Art

With reduction in size and thickness of electronic devices such as personal computers, demands for reduction in size and thickness of disk drives for use in the electronic devices have been increasing. To satisfy the demands, a disk drive having the following structure has been proposed. In the disk drive, a disk-shaped storage medium (hereinafter, simply referred to as a disk), a spindle motor, a magnetic head, an actuator for the magnetic head, and the like are accommodated in a concave portion formed on one side of a base plate. The base plate is formed of aluminum by die casting, for example. An opening of the base plate is sealed with a cover plate.

On the other side of the base plate is mounted a control circuit board which includes control circuits for the spindle motor, the magnetic head, the actuator, and the like and a circuit for providing an interface with an electronic device on which the disk drive is used.

In a case where the above-described base plate is formed by using a mold (for example, by die casting of aluminum), an error in a finished dimension increases as a degree of wear of the mold becomes larger. Especially, in a cylindrical concave portion for accommodating the disk therein (hereinafter, referred to as a disk-accommodating concave portion), it is difficult to accurately form a corner between a bottom face and an inner wall at a right angle. For example, the corner becomes blunt or rounded, so that a surface around the corner is raised toward an opening of the base plate.

To reduce a manufacturing cost of the base plate, it is desirable that as many as possible base plates be molded by using a single mold. However, in a case where the right-angle corner in the disk-accommodating concave portion is not accurately formed as described above, a gap (clearance) between an outer circumferential surface of the disk and an inner wall of the disk-accommodating concave portion becomes small. The reduction in clearance may cause contact of the disk with the concave portion, resulting in a rotation failure.

Moreover, further reduction in size and thickness of the disk drive may make it difficult to obtain desired precision of the disk-accommodating concave portion of the base plate only by depending on molding precision. In particular, it is difficult to ensure a gap (clearance) between the outer circumferential surface of the disk and the disk-accommodating concave portion with high precision. Needless to add, the base plate has to be manufactured at a reduced cost. Therefore, it is necessary to consider a comprehensive manufacturing cost including a cost of the mold and the number of shots for each mold.

### SUMMARY OF THE INVENTION

According to a preferred embodiment of the present invention, a base plate includes a first face and a second face. A concave portion accommodating a disk-shaped storage medium is formed on the first face, while a control circuit board is secured on the second face.

The concave portion includes a bottom face having an outer edge that is at least partially arc-shaped and a wall arranged substantially at a right angle with respect to the bottom face.

The base plate is manufactured in the following manner. First, a work-in-process piece for the base plate is obtained by forcing molten material into a cavity of a mold and separating the material after being solidified from the mold. A face of the mold for forming the first face of the base plate is shaped in accordance with a shape of the first face. The obtained work-in-process piece has a first face similarly shaped to the first face of the base plate and includes a concave portion having a bottom face and a wall respectively corresponding to the bottom face and the wall of the base plate. Then, a portion of the thus obtained work-in-process piece is cut to obtain the base plate. The cut portion corresponds to a portion of the base plate at which the bottom face and the wall are connected to each other in the concave portion.

The term “work-in-process piece” means a part in process for which a manufacturing process of the base plate is not finished and which is not subjected to cutting, i.e., an unfinished base plate. The work-in-process piece can be obtained by casting, for example. The material for the base plate is aluminum for die casting, for example. The same is applied to the following structure.

In an exemplary embodiment of the present invention, the work-in-process piece for the base plate, after being shaped, is cut by using a jig. Therefore, it is possible to easily ensure appropriate finished precision of the disk-accommodating concave portion.

Moreover, the cutting process can make up for lowering of molding precision caused by mold wear. Therefore, the number of shots for each mold can be increased, thus reducing a comprehensive manufacturing cost.

Other features, elements, advantages and characteristics of the present invention will become more apparent from the following detailed description of preferred embodiments thereof with reference to the attached drawings.

### BRIEF DESCRIPTION OF THE DRAWINGS

FIGS. 1A and 1B are perspective views of a base plate for use in a disk drive according to a preferred embodiment of the present invention.

FIG. 2 is a cross-sectional view of an outer circumferential surface of a disk and a disk-accommodating concave portion of the base plate of FIG. 1 when the disk is mounted on the base plate of FIG. 1.

FIG. 3 is a general flowchart of a method for manufacturing a base plate according to a preferred embodiment of the present invention.

FIG. 4 is a general flowchart of cutting a work-in-process piece for the base plate according to the preferred embodiment of the present invention.

FIGS. 5A and 5B show a jig used in the cutting of the work-in-process piece.

FIGS. 6A and 6B show the jig used in the cutting of the work-in-process piece together with the work-in-process piece placed on the jig.

FIG. 7 is a plan view of the work-in-process piece after the cutting.

FIG. 8 generally shows an exemplary spindle motor unit using a base plate according to a preferred embodiment of the present invention.

FIG. 9 generally shows an exemplary disk drive using a base plate according to a preferred embodiment of the present invention.

FIG. 10 is a photograph of a part of an inner surface of the base plate after the cutting.

FIG. 11 is a photograph of a part of the inner surface of the base plate after the cutting, taken from a diagonal view.

### DETAILED DESCRIPTION OF PREFERRED EMBODIMENTS

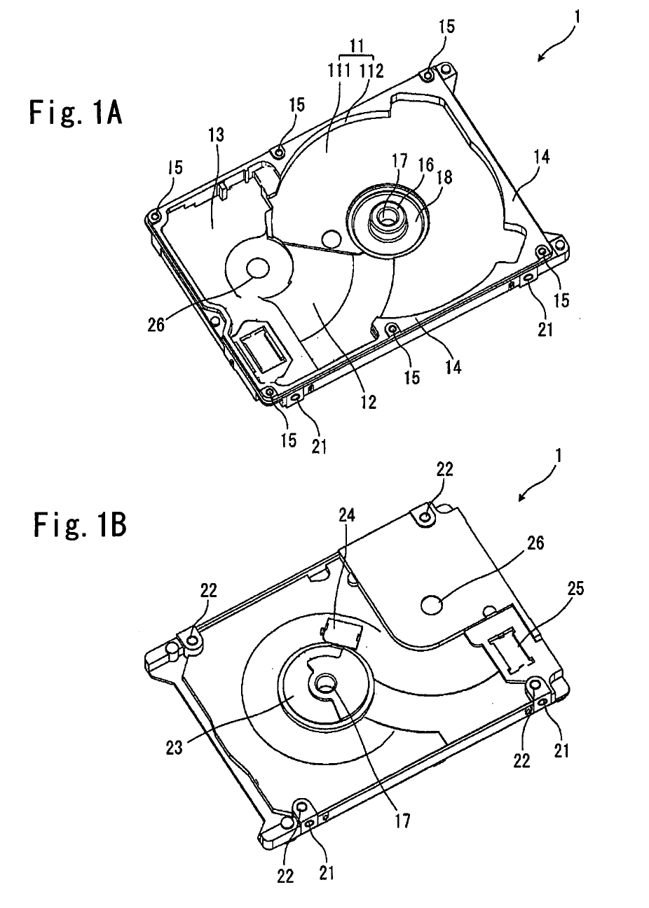

Referring to FIGS. 1A through 11, a preferred embodiment of the present invention will be described in detail. It should be noted that in the explanation of the present invention, when positional relationships among and orientations of the different components are described as being up/down or left/right, ultimate positional relationships and orientations that are in the drawings are indicated; positional relationships among and orientations of the components once having been assembled into an actual device are not indicated. Meanwhile, in the following description, an axial direction indicates a direction parallel to a rotation axis of a disk and a spindle motor that are to be assembled with a base plate, and a radial direction indicates a direction perpendicular to the rotation axis.

FIGS. 1A and 1B are perspective views of a base plate 1 for use in a disk drive according to a preferred embodiment of the present invention, when seen from a first-face (inner-face) side and a second-face (outer-face) side, respectively.

The base plate 1 is an approximately plate-like member formed of metal. For example, the base plate 1 is an aluminum die casting. The first face of the base plate 1 has a concave portion formed thereon for accommodating a disk (e.g., a hard disk), a spindle motor, a magnetic head, an actuator for the magnetic head, and the like. On the second face is secured a control circuit board.

As shown in FIG. 1A, the concave portion on the first face (inner face) includes a disk-accommodating concave portion 11 which accommodates a disk, and other concave portions 12 and 13. The concave portion 12 accommodates a magnetic head which concaves at least one of writing and reading of information on/from the disk and a supporting arm which supports the magnetic head. The concave portion 13 accommodates an actuator which moves the magnetic head and the supporting arm.

A sealing plane 14 is provided around those concave portions 11, 12, and 13, i.e., along four sides of the base plate 1 that is approximately rectangular when seen from a direction perpendicular to the base plate 1 (that is parallel to the axial direction). When a cover plate (not shown) is placed on the sealing plane 14, the first face of the base plate 1 is sealed with the cover plate. In sealing of the first face, a sealing member (e.g., rubber packing) is interposed between the cover plate and the sealing plane 14. On the sealing plane 14, screw holes 15 are provided at six locations that are four corners of the rectangle and around a center of each longer side.

When the cover plate is fastened to the first face of the base plate 1 with six screws (not shown) inserted into the screw holes 15 at the above-described six locations, the disk-accommodating concave portion 11 and the concave portions 12 and 13, all of which are formed on the first face, are enclosed with the base plate 1 and the cover plate.

The disk-accommodating concave portion 11 includes a bottom face 111 and an inner wall 112. The bottom face 111 has an outer edge that is at least partially arc-shaped. The inner wall 112 is connected to the outer edge of the bottom face 111 and is arranged substantially at a right angle with respect to the bottom face 111. At a center of the bottom face 111, a cylindrical projection 116 projecting from the bottom face 111 substantially at a tight angle is formed. An inner circumferential surface of the cylindrical projection 16 defines a hole 17 in which a bearing (not shown) of a spindle motor is arranged. A rotor of the spindle motor is also arranged to go through the hole 17. A stator (not shown) of the spindle motor is arranged outside the cylindrical projection 16. In addition, a stator-accommodating concave portion 18 for accommodating a part of the stator is formed around the cylindrical projection 16. The stator-accommodating concave portion 18 is deeper than the disk-accommodating concave portion 11. That is, a bottom of the stator-accommodating concave portion 18 is located below the bottom face 111 of the disk-accommodating concave portion 18.

In each side face of the base plate 1 along its longer sides, screw holes 21 are formed at two locations, as shown in FIGS. 1A and 1B. That is, the base plate 1 has total four screw holes 21 on its side faces. The screw holes 21 are used for securing a disk drive in which the base plate 1 is included to an electronic device into which that disk drive is incorporated.

On the second face (i.e., outer face) of the base plate 1 shown in FIG. 1B, a control circuit board (not shown) is secured. The control circuit board is a printed circuit board on which a circuit for providing an interface with the electronic device, control circuits for the spindle motor, a magnetic head, and an actuator, and the like are mounted. Screw holes 22 used for securing the control circuit board on the second face are formed at four locations near four corners of the second face.

A fan-shaped concave portion 23 and another concave portion 24 are formed on the second face around the hole 17. The fan-shaped concave portion 23 accommodates an FPC (flexible printed circuit board) on which the driving circuit for the spindle motor is mounted. The concave portion 24 accommodates a connector which connects the FPC to the above-described circuit board.

The second face of the base plate 1 also includes a rectangular hole 25 formed therein, through which a connector for electrically connecting the circuit board to the magnetic head and actuator is inserted. Coils of the stator of the spindle motor attached to the first face of the base plate 1 are drawn out to the second face through a plurality of small holes (not shown) formed in the stator-accommodating concave portion 18 and are connected to the FPC on the second face. A round hole 26 formed near the rectangular hole 25 holds a shaft serving as a center of pivotal movement of the supporting arm which supports and moves the magnetic head approximately in a radial direction of the disk.

The base plate 1 is formed by using a mold. For example, the base plate 1 is an aluminum die-casting. With increase in the number of times of molding using the same mold, a degree of wear of the mold becomes larger and therefore precision in dimension of the molded base plate is lowered. Especially, angular precision of a corner in the disk-accommodating concave portion at which the bottom face and the inner wall are connected to each other is degraded. In some cases, that corner may blunt or be rounded so that a raised portion is formed at the corner.

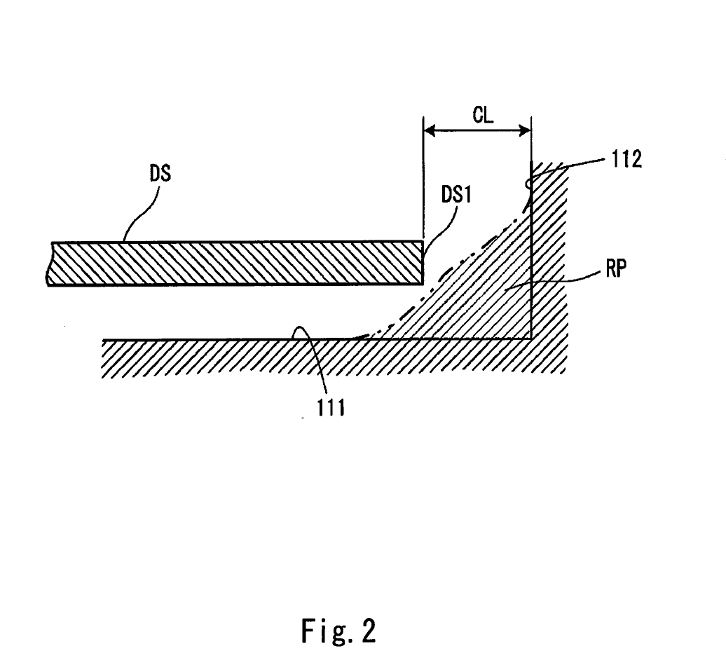

FIG. 2 is a cross-sectional view schematically showing an outer circumferential surface of the disk and the disk-accommodating concave portion 11, when the disk is accommodated in the disk-accommodating concave portion 11 of the base plate 1. As shown in FIG. 2, a raised portion RP is formed at the corner between the bottom face 111 and the inner wall 112 of the disk-accommodating concave portion 11 because of wear of the mold. As the raised portion RP becomes larger, a clearance CL between the outer circumferential surface DS1 of the disk DS and the inner wall 112 becomes smaller.

In addition, the outer circumferential surface DS1 of the disk DS may come into contact with the raised portion RP, causing a rotation failure. For example, the clearance CL is set to about 200 μm in a 2.5-inch disk drive (hard disk drive). In a disk drive having a further reduced size, the clearance CL is further reduced.

In a method for manufacturing the base plate 1 in this embodiment, the raised portion RP described above is removed by performing a cutting process for a work-in-process piece for the base plate 1 that is obtained by casting, i.e., an unfinished base plate.

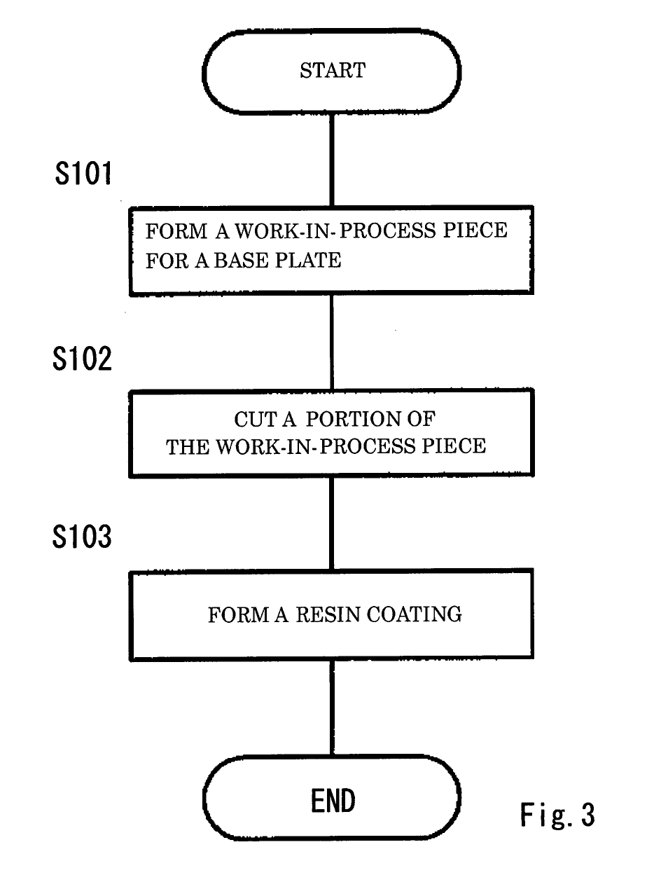

FIG. 3 is a general flowchart of the method for manufacturing the base plate according to a preferred embodiment of the present invention.

First, the work-in-process piece for the base plate 1 is formed by casting (Step S101). In Step S101, a mold (die) is prepared, which has an inner face shaped in accordance with the shape of the disk-accommodating concave portion 11 and concave portions 12 and 13 of the base plate 1 as a face for forming the first face of the base plate 1. Then, molten material for the base plate 1 is forced into a cavity in the mold. The material is separated from the mold, after being solidified. The separated material is used as the work-in-process piece for the base plate 1 in the following processes. The thus obtained work-in-process piece has a first face corresponding to the first face of the base plate 1. That is, the first face of the base plate 1 includes a concave portion, which corresponds to the disk-accommodating concave portion 11 of the base plate 1, and has a bottom face and an inner wall respectively corresponding to the bottom face 111 and the inner wall 112 of the base plate 1, for example. Thus, in the following description of the manufacturing of the base plate 1, the work-in-process piece is labeled with the same reference numeral as the base plate 1 and portions of the work-in-process piece which correspond to portions of the base plate 1, respectively, are referred to with the same name and reference numerals as those of the portions of the base plate 1 for the sake of convenience.

In this embodiment, the material for the base plate is aluminum. Other metal, e.g., magnesium, may be used. Alternatively, the work-in-process piece may be formed from powder metal by compression molding or by using a powder metallurgical technique.

Next, a cutting process is performed for the thus obtained work-in-process piece 1 (Step S102). More specifically, a portion of the work-in-process piece 1, at which the bottom face 111 and the inner wall 112 of the disk-accommodating concave portion 11 are connected to each other, is cut so as to remove the raised portion RP formed at that portion. Details of Step S102 will be described later.

After the cutting, a resin coating is formed on a surface of the work-in-process piece 1 (Step S103). In this embodiment, the work-in-process piece 1 after the cutting is finished is cleaned, and thereafter a black resin coating is formed on the surface of the work-in-process piece 1 by electrodeposition. The thickness of the resin coating is 50 μm or less, for example. In formation of the resin coating, the stator-accommodating concave portion 18 formed at the center of the bottom face 111 of the disk-accommodating concave portion 11, the screw holes 15, 21, and 22, and the like are masked so as to prevent the resin coating from being formed thereon.

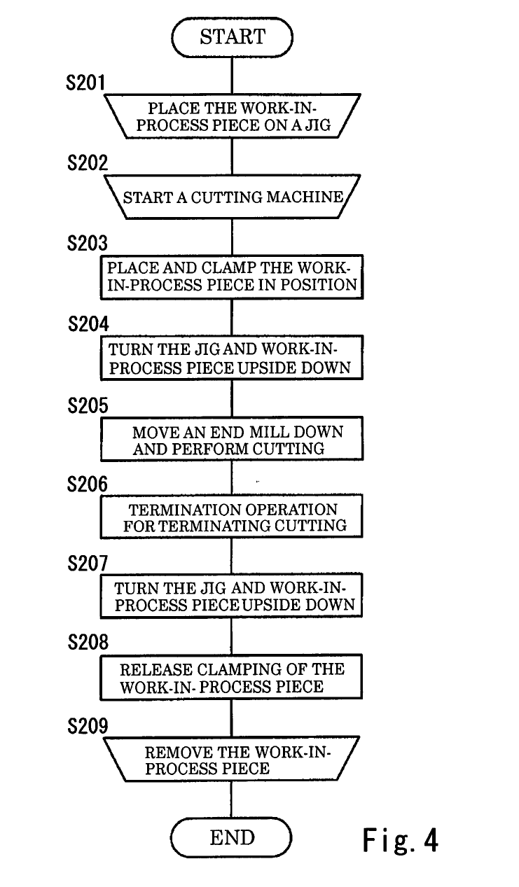

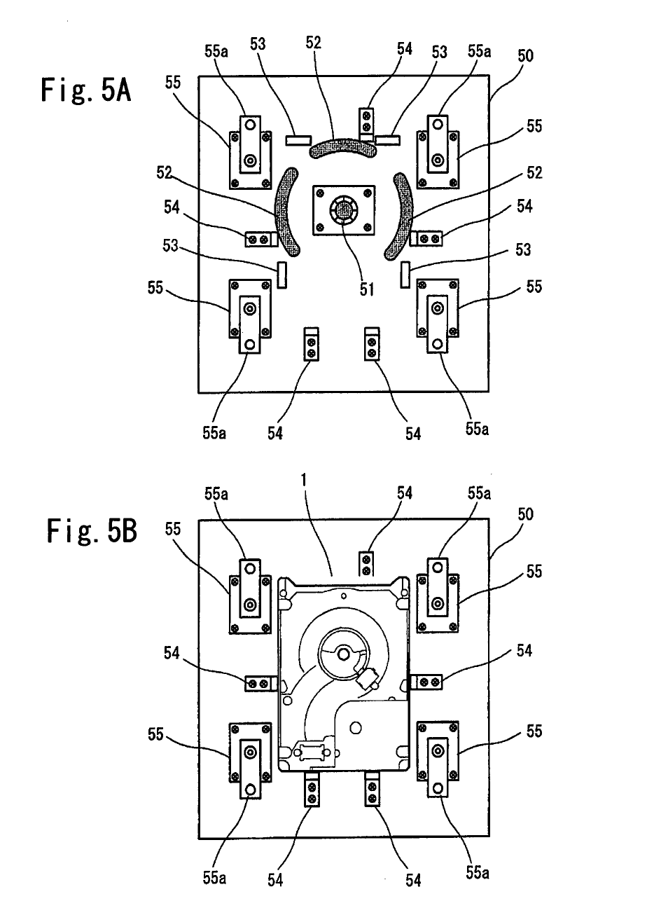

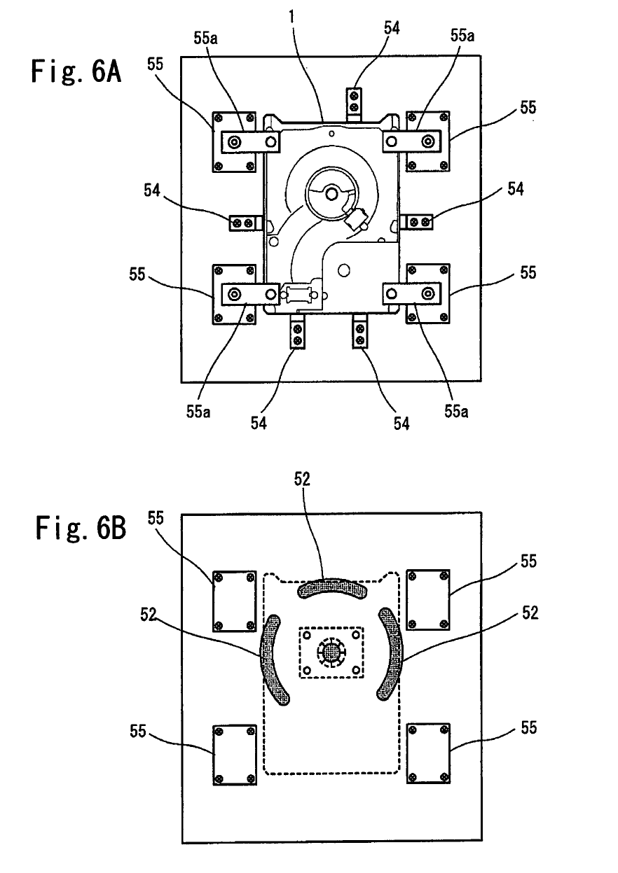

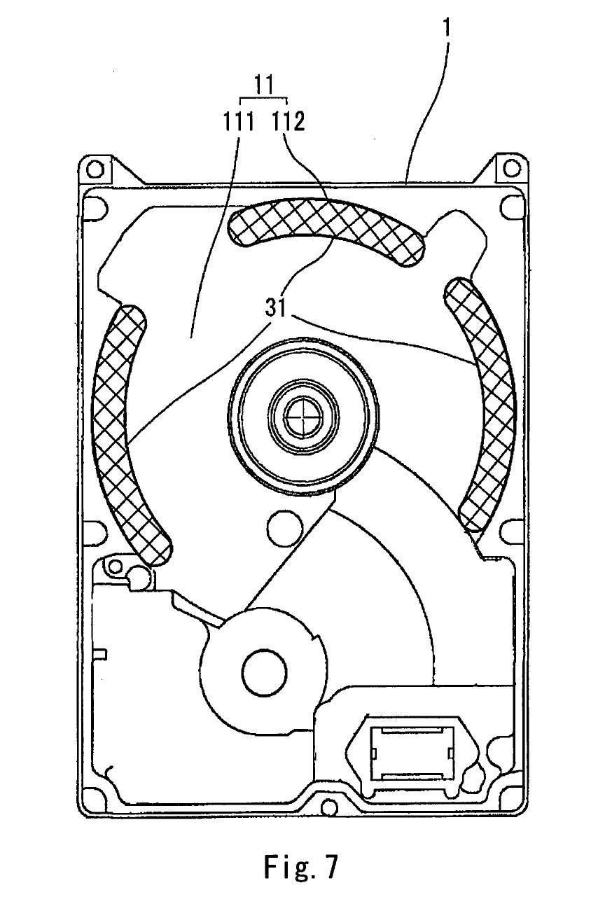

The cutting process performed for the work-in-process piece 1 in this embodiment is now described in detail, with reference to FIGS. 4 to 7. FIG. 4 is a detailed flowchart of the cutting process in this embodiment. FIGS. 5A, 5B, 6A, and 6B are top views of a processing jig used in the cutting of the work-in-process piece 1 in different steps of the manufacturing process. FIG. 7 is a general plan view of an inner-face side of the base plate (work-in-process piece) 1 after the cutting is finished.

FIG. 5A shows the processing jig 50 (hereinafter, simply referred to as jig 50) before the work-in-process piece 1 is placed thereon. FIG. 5B shows the jig 50 with the work-in-process piece 1 placed thereon.

The jig 50 includes a metal base in the form of a thick plate, a holding jig for holding the work-in-process piece 1 placed on the metal plate, and a cutting-tool insertion hole which allows a cutting tool to be inserted therethrough. An end mill is used as the cutting tool, for example.

Although FIGS. 5A to 6B show the jig 50 used for cutting a single work-in-process piece 1 placed thereon, two or more work-in-process pieces 1 may be placed on the jig 50 side by side to allow simultaneous cutting to be carried out. In this case, production efficiency can be improved.

As shown in FIG. 5A, a collet chuck 51 which can engage with the cylindrical projection 16 (see FIG. 1A) of the work-in-process piece 1 is arranged approximately at a center of the jig 50. The collet chuck 51 comes into contact with the cylindrical projection 16 of the work-in-process piece 1, thereby appropriately positioning the center of the jig 50 with respect to the inner wall 112 of the work-in-process piece 1 (that is arc-shaped when seen from the direction perpendicular to the first face) in a radial direction of the inner wall 112 that is coincident with the radial direction of the cylindrical projection 16. That is, the collet chuck 51 serves as a second contact portion recited in the claims.

Cutting-tool insertion holes 52 that are arc-shaped are formed around the collet chuck 51. Each insertion hole 52 allows a cutting tool to be inserted therethrough. In the example of FIG. 5A, three cutting-tool insertion holes 52 are arranged on a circumference of a circle centering on a center of the collet chuck 51. This arrangement of the cutting-tool insertion holes 52 is designed for a case where a portion of the work-in-process piece 1 to be cut is divided into three sub-portions in accordance with the shape of the disk-accommodating concave portion 11 shown in FIG. 1A. However, the number of the cutting-tool insertion holes is not limited to three. The number of the cutting-tool insertion holes can be set to two, or more than three in accordance with the shape of the disk-accommodating portion 11. Alternatively, one cutting-tool insertion hole that is continuous and arc-shaped may be formed if a sufficient level of mechanical strength is ensured.

On the metal base of the jig 50, four projecting blocks 53 are arranged to correspond to three sides of an outer edge of the work-in-process piece 1. Each projecting block 53 comes into contact with the sealing plane 14 of the work-in-process piece 1, thereby placing the jig 50 in position with respect to the bottom face 111 of the work-in-process piece 1 in the direction perpendicular to the first face. That is, the projecting block 53 serves as a first contact portion recited in the claims.

Moreover, five positioning members 54 formed of resin are provided on the metal base of the jig 50, as shown in FIG. 5B. Those positioning members 54 provisionally position four sides of the outer edge of the work-in-process piece 1 when the work-in-process piece 1 is attached to the jig 50. A predetermined clearance is formed between each of those positioning members 54 and the outer edge of the work-in-process piece 1. Precise positioning of the work-in-process piece 1 with respect to the jig 50 is achieved by restricting movement of the work-in-process piece 1 in both the radial (horizontal) direction of the cylindrical projection 16 and the direction perpendicular to the bottom face 111 (that is coincident with the axial direction of the rotation axis of the disk to be mounted on the disk-accommodating concave portion).

That is, engagement of the cylindrical projection 16 of the work-in-process piece 1 with the collet chuck 51 of the jig 50 places the center of the jig 50 (i.e., a center of an arc-shaped locus of the end mill) in position with respect to the work-in-process piece 1 in the radial direction of the cylindrical projection 16. Contact of the sealing plane 14 of the work-in-process piece 1 with the projecting blocks 53 of the jig 50 places the jig 50 in position with respect to the bottom face 111 of the work-in-process piece 1 in the direction perpendicular to the bottom face 111 (i.e., a direction in which the end mill is run out).

Four cylinder clampers 55 are provided on a top face of the jig 50. The cylinder clampers 55 clamp four corners of the work-in-process piece 1, which correspond to four corners of the base plate 1, respectively, by pressing them in a direction perpendicular to the top face of the jig 50, i.e., in the axial direction as defined above, while the sealing plane 114 of the work-in-process piece 1 is in contact with the projecting blocks 53 of the jig 50.

Each cylinder clamper 55 includes a clamping arm 55a attached to a tip of a plunger (not shown) which can extend and contract in the direction perpendicular to the top face of the jig 50. The clamping arm 55a is pivotally movable by 90 degrees around an axial center of the plunger toward the cylindrical projection 16 of the work-in-process piece 1 placed on the jig 50 (see FIG. 6A).

The cutting using the jig 50 having the above-described structure is described based on the flowchart of FIG. 4.

First, the work-in-process piece 1 formed in Step S101 in the flowchart of FIG. 3 is placed on the top face of the jig 50 (Step S201), as shown in FIG. 5B. Then, a start button of a cutting machine is pressed down to start a program of the cutting machine (Step S202).

In Step S203, the cylindrical projection 16 of the work-in-process piece 1 is chucked by the collet chuck 51 of the jig 50, and four corners of the work-in-process piece 1 are held with pressure by the claming arms 55a of the cylinder clampers 55, respectively, as shown in FIGS. 5B and 6A.

More specifically, the clamping arms 55a of the four cylinder clampers 55 pivotally move around the axial centers of the associated plungers toward the cylindrical projection 16 of the work-in-process piece 1 by 90 degrees and thereafter the plungers move down along their axial centers (i.e., in the direction perpendicular to the top face of the jig 50). As a result, four corners of the work-in-process piece 1 are held while being pressed against the top face of the jig 50.

To make the structure of the jig 50 simple, the clamping arms 55a may be pivotally moved toward the cylindrical projection 16 of the work-in-process piece by 90 degrees by a manual operation. In this case, the work-in-process piece 1 is placed on the jig 50, as shown in FIG. 5B, then the clamping arms 55a of the four cylinder clampers 55 are pivotally moved toward the cylindrical projection 16 of the work-in-process piece by 90 degrees, as shown in FIG. 6A, and thereafter the cutting machine is started. When the program of the cutting machine starts, the cutting machine chucks the cylindrical projection 16 of the work-in-process piece 1 by means of the collet chuck 51 of the jig 50 and moves the plungers of the cylinder clampers 55 down along the axial centers of the plungers. In this manner, the cutting machine holds four corners of the work-in-process piece 1 while pressing them against the top face of the jig 50.

After the work-in-process piece 1 is secured on the jig 50, the jig 50 is turned upside down (Step S204). As a result, the face of the jig 50 with the work-in-process piece 1 secured thereon is located on a lower side while a face opposed to that face is located on an upper side. FIG. 6B shows this state.

In this state, the cutting-tool insertion holes 52 that are arc-shaped appear in the face located at the upper side and therefore a portion of the work-in-process piece 1, at which the bottom face 111 and the inner wall 112 are connected to each other, can be observed with eyes through the cutting-tool insertion holes 52. This portion is to be cut.

In this state, an end mill as the cutting tool of the cutting machine is moved down in accordance with the process program, goes through the cutting-tool insertion hole 52, and reaches the portion to be cut of the work-in-process piece 1 (Step S205). The end mill then rotates and moves on an arc-shaped locus in accordance with the process program, and performs a predetermined cutting process during the movement.

The cutting using the end mill is carried out based on the sealing plane 14 of the work-in-process piece 1 as a reference plane. In this embodiment, the cutting is carried out by using the end mill until a distance between the sealing plane 14 and a corner at which the bottom face 111 and the inner wall 112 are connected to each other in the direction perpendicular to the bottom face, i.e., in the axial direction reaches about 3.5 mm. In a case of using the sealing plane 14 of the work-in-process piece 1 as a reference plane for positioning, the number of processes can be reduced as compared with a case where the reference plane is formed on the second face of the work-in-process piece 1 by cutting, for example. Moreover, process precision can be improved.

As described before, the work-in-process piece 1 is appropriately placed in position with respect to the jig 50. In other words, a center of the arc-shaped locus of the end mill is placed in position by engagement of the cylindrical projection 16 of the work-in-process piece 1 with the collet chuck 51 of the jig 50, while the end mill is appropriately placed in position in the direction perpendicular to the top face of the jig 50 (i.e., the direction in which the end mill is run out) by contact of the sealing plane 14 of the work-in-process piece 1 with the projecting block 53 of the jig 50.

Therefore, the cutting machine can cut the work-in-process piece 1 with high precision in accordance with the process program. The use of the cutting machine including the end mill for cutting the work-in-process piece 1 can suppress variations in processing quality and can ensure reliable cutting with high precision, as compared with manual cutting. Thus, yields can be improved.

After the cutting is finished, the cutting machine carries out a termination operation in accordance with the process program in Step S206. In the termination operation, rotation of the end mill is stopped and thereafter the end mill is elevated to its original position at which the end mill is located before the start of the cutting process.

Then, the jig 50 is turned upside down together with the work-in-process piece 1, so that the face of the jig 50 on which the work-in-process piece 1 is placed faces up (Step S207). Subsequently, pressure application to the work-in-process piece 1 is released and thereafter the clamping arms 55a move away from the work-in-process piece 1 to release the work-in-process piece 1. That is, the jig 50 is returned to the state shown in FIG. 5B. In this state, the work-in-process piece 1 can be removed from the jig 50 (Step S209).

In a case where the clamping arms 55a are manually operated as described above, the claming arms 55a are manually pivotally moved by 90 degrees, so that the jig 50 is placed in the state shown in FIG. 5B. Then, the work-in-process piece 1 is removed from the jig 50.

FIG. 7 shows an inner-face side of the work-in-process piece 1 after being cut. That is, FIG. 7 shows the inner-face side of the base plate 1 manufactured in the aforementioned manner. Three arc-shaped regions 31 shown with cross-hatching in FIG. 7 are regions cut by the end mill. As a result of the cutting, the raised portion RP (see FIG. 2) formed due to wear of the mold at the corner between the bottom face 111 and the inner wall 112 in the disk-accommodating concave portion 11 is removed.

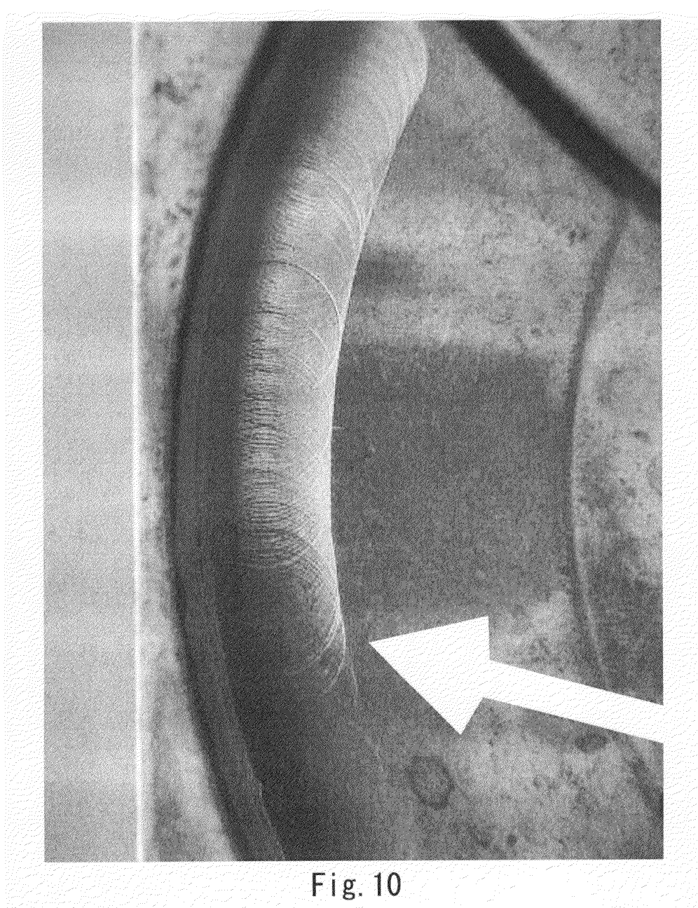

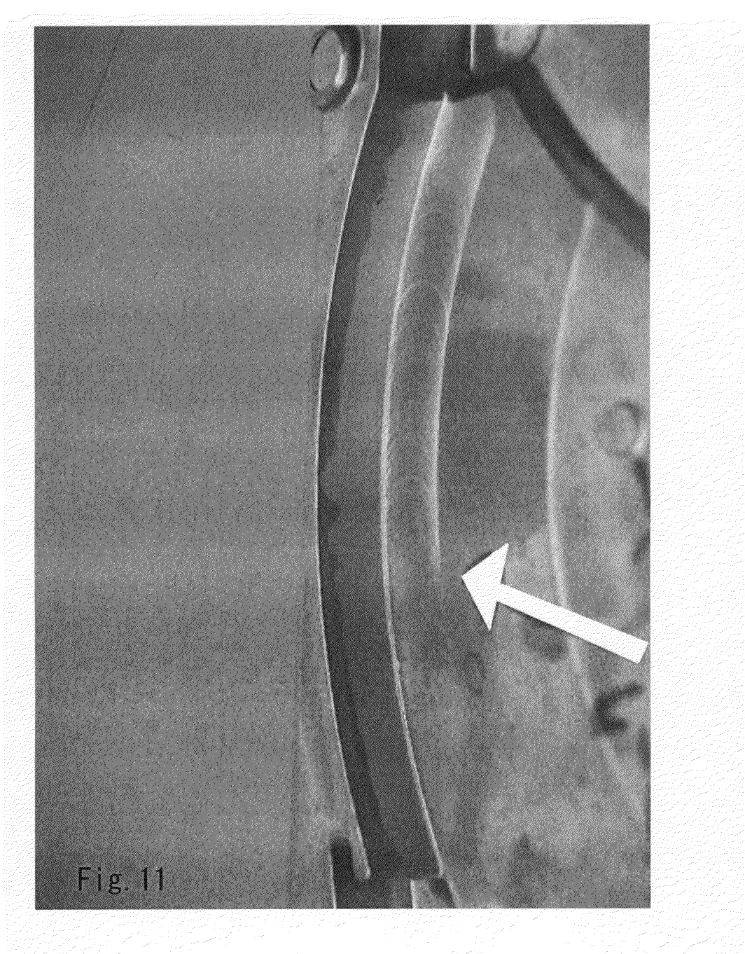

In the cut regions 31, a cutting mark is formed on the bottom face 11, as shown in FIGS. 10 and 11. The cutting mark is formed during rotation and movement of the end mill on an arc-shaped locus, and includes circular marks overlapping each other.

FIGS. 10 and 11 are photographs showing a part of the inner-face side of the base plate 1 after the cutting process. The part shown in those photographs is a part of a left one of the three cut regions 31 shown in FIG. 7. The photograph of FIG. 10 is taken when the bottom face 111 is seen in the direction perpendicular thereto, while the photograph of FIG. 11 is taken when the bottom face 111 is seen in a direction at an angle to the direction of FIG. 10. White arrow indicates where the cutting mark is formed.

After the cutting process, the base plate 1 is cleaned and subjected to electrodeposition, as described before with reference to the flowchart of FIG. 3. A resin coating having a thickness of 50 μm or less is formed on a surface of the base plate 1 by electrodeposition. Although the resin coating is formed in the cut regions 31, the cutting mark is still visible. Even if the cutting mark remains on the bottom face 111, it has no adverse effect on functions of the base plate 1. In this manner, the base plate 1 is manufactured.

Next, a spindle motor unit and a disk drive that use the thus manufactured base plate 1 are described.

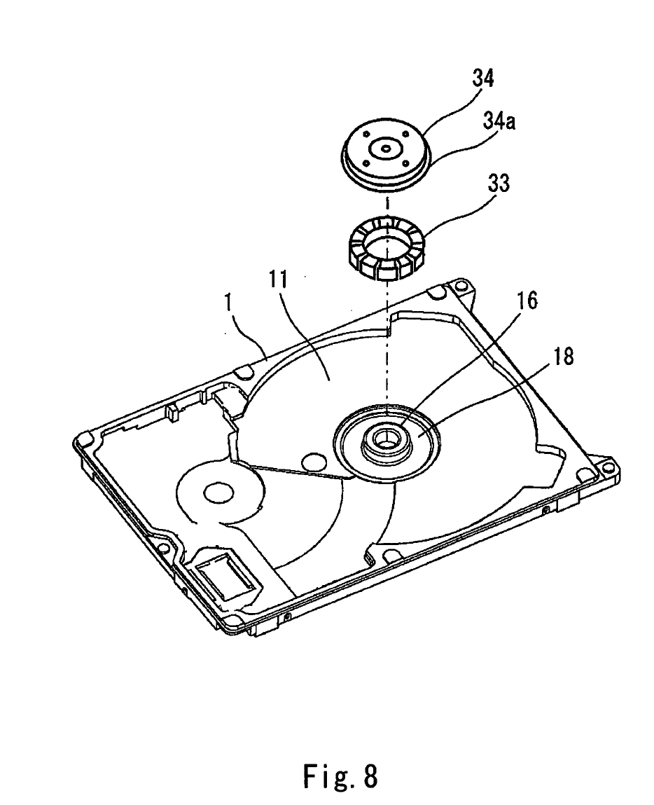

FIG. 8 is a diagram generally showing assembly of the spindle motor unit using the base plate according to a preferred embodiment of the present invention. A stator 33 as a part of the spindle motor is secured to an outer circumferential surface of the cylindrical projection 16 provided at the center of the disk-accommodating concave portion 11. A part of the stator 33 is accommodated in the stator-accommodating concave portion 18 formed around the cylindrical projection 16.

The stator 33 includes a plurality of teeth arranged regularly in a circumferential direction to form a core. A coil is wounded around each tooth with an insulator interposed between the coil and the tooth. An inner circumferential surface of the stator 33 is attached to the outer circumferential surface of the cylindrical projection 16.

A rotor 34 as a part of the spindle motor is arranged to cover the stator 33. The rotor 34 is approximately cylindrical and includes an outer circumferential surface and a flange portion 34a. The outer circumferential surface of the rotor 34 engages with a center hole of a disk. The flange portion 34a supports a lower surface of the disk.

The rotor 34 includes a cylindrical rotor magnet (not shown) opposed to the outer circumferential surface of the stator 33 with a gap sandwiched therebetween. At a center of the rotor 34, a shaft, which is inserted through the hole 17 in the cylindrical projection 16 and is rotatably supported, is fixed.

In FIG. 8, the outer face (the second face) of the base plate 1 is not shown. To the outer face, a flexible printed circuit board (FPC) on which a driving circuit for the spindle motor is mounted is attached. Wirings from the coils of the stator 33 are drawn out to the outer face of the base plate 1 through a plurality of small holes formed in the stator-accommodating concave portion 18, and are connected to the FPC.

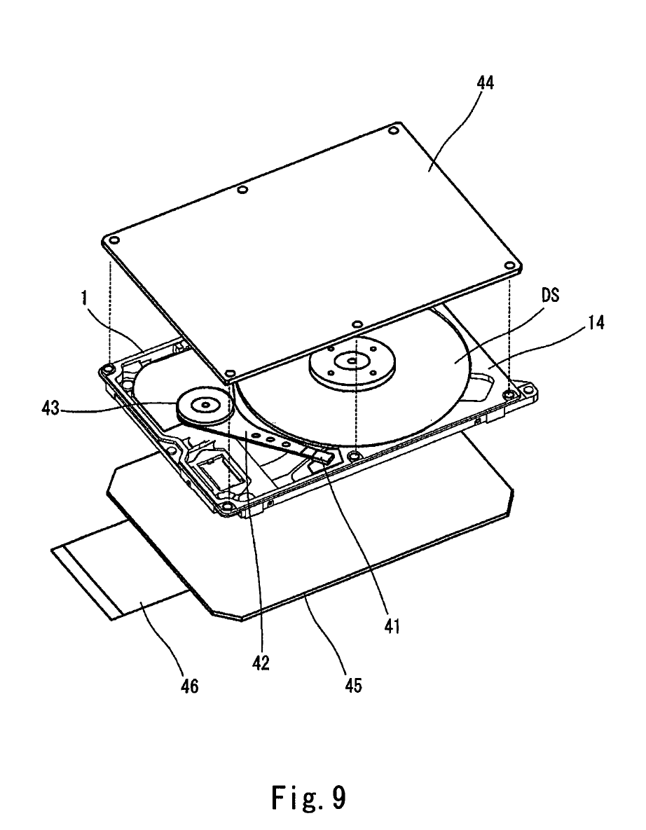

FIG. 9 shows assembly of a disk drive using the base plate 1 according to a preferred embodiment of the present invention. The disk drive includes the spindle motor unit of FIG. 8 and also includes a disk-shaped storage medium (hard disk) DS, a magnetic head 41, an arm 42 and an actuator 43 for the magnetic head 41, and the like are accommodated in the concave portion on the inner surface (first face) of the base plate 1. A cover plate 44 is placed on the inner-face side of the base plate 1, so that the concave portion on the inner face of the base plate 1 is sealed with a lower peripheral portion of the cover plate 44 and the sealing plane 14 of the base plate 1 with a sealing member (e.g., rubber packing member) interposed between the sealing plane 14 and the cover plate 44.

Thus, the concave portion of the base plate 1, in which the spindle motor, the disk, the magnetic head, the actuator, and the like are accommodated, forms a space enclosed with the base plate 1 and the cover plate 44.

On the outer face (second face) of the base plate 1 is secured a control circuit board 45. The control circuit board 45 is a printed circuit board on which a circuit for providing an interface with an electronic device and control circuits for the spindle motor, magnetic head, and actuator are mounted. The control circuit board 45 is electrically connected to the magnetic head 41 and the actuator 43 via a connector, and is also electrically connected to the above-described FPC for the spindle motor. An FPC connector 46 is connected to one end of the control circuit board 45. Electrical connection between the control circuit board 45 and an electronic device in which the disk drive is included is achieved by the FPC connector 46.

The preferred embodiment of the present invention is described in the above, referring to various modifications. However, the present invention is not limited thereto but can be modified in various ways.

For example, the work-in-process piece may be obtained by any known methods, e.g., injection molding using resin and metal injection molding using metal.

Moreover, the disk drive including the motor can be used not only for driving a hard disk but also for driving other storage media in the form of a disk, such as an optical disk and a magnetooptical disk.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A manufacturing method for a base plate for use in a disk drive, the base plate including a first face and a second face opposed to the first face, the first face including a concave portion formed thereon which accommodates a disk-shaped storage medium and has a bottom face and a wall arranged substantially at a right angle with respect to the bottom face, the manufacturing method comprising:
obtaining a work-in-process piece by forcing molten material for the base plate into a cavity of a mold and separating the material after being solidified from the mold, wherein a face of the mold for forming the first face of the base plate is shaped in accordance with a shape of the first face, and the obtained work-in-process piece has a first face similarly shaped to the first face of the base plate to include a concave portion having a bottom face and a wall respectively corresponding to the bottom face and the wall of the base plate; and
cutting a portion of the work-in-process piece, which corresponds to a portion of the base plate at which the bottom face and the wall are connected to each other in the concave portion, to obtain the base plate.

2. The manufacturing method according to claim 1, wherein the first face of the base plate includes a sealing plane arranged around the concave portion, the sealing plane extending from an end of the wall opposite to another end connected to the bottom face, the work-in-process piece including a sealing plane corresponding to the sealing plane of the base plate, and
the cutting of the work-in-process piece is performed by using the sealing plane of the work-in-process piece as a reference for positioning.

3. The manufacturing method according to claim 2, wherein, in the obtaining of the work-in-process piece, a cylindrical projection is formed at a center of the concave portion of the work-in-process piece to project substantially at a right angle from the bottom face of the work-in-process piece, and
the cutting of the work-in-process piece is performed with the cylindrical projection placed in position.

4. The manufacturing method according to claim 3, wherein the cutting of the work-in-process piece uses a jig including: a first contact portion which comes into contact with the sealing plane of the work-in-process piece and places it in position in a direction perpendicular to the bottom face of the work-in-process piece; and a second contact portion which places the cylindrical projection of the work-in-process piece in position in a radial direction of the cylindrical projection, and
the cutting is performed while the work-in-process piece is placed in position in both the direction perpendicular to the bottom face of the work-in-process piece and the radial direction of the cylindrical projection.

5. The manufacturing method according to claim 4, wherein the jig includes a through hole which allows a cutting tool to go through and reach the work-in-process piece placed on the jig, and
in the cutting of the work-in-process piece, a surface of the portion of the work-in-process piece corresponding to the portion of the base plate at which the bottom face and the wall are connected to each other is cut by the cutting tool inserted through the through hole of the jig.

6. The manufacturing method according to claim 5, further comprising, prior to the cutting of the work-in-process piece, placing and securing the work-in-process piece on the jig and then turning the jig and the work-in-process piece upside down together.

7. The manufacturing method according to claim 1, wherein, in the obtaining of the work-in-process piece, a cylindrical projection is formed at a center of the concave portion of the work-in-process piece to project substantially at a right angle from the bottom face of the work-in-process piece, and
the cutting of the work-in-process piece is performed with the cylindrical projection placed in position.

8. The manufacturing method according to claim 1 further comprising, after the cutting of the work-in-process piece, forming a resin coating on a surface of the bottom face and wall of the work-in-process piece.

9. The manufacturing method according to claim 1, wherein the cutting of the work-in-process piece is performed by using an end mill.

10. A base plate for use in a disk drive, comprising a first face and a second face opposed to the first face, wherein
the first face includes a concave portion which accommodates a disk-shaped storage medium, the concave portion including a bottom face having an outer edge at least partially arc-shaped and a wall arranged substantially at a right angle with respect to the bottom face, and
a cutting mark is formed by machining on a surface of the first face of the base plate near a corner formed by the bottom face and the wall of the concave portion.

11. The base plate according to claim 10, wherein a plurality of circular marks overlapping each other form the cutting mark.

12. The base plate according to claim 10, wherein the wall is arranged to form a gap of 200 μm or less between the wall and an outer circumference of the disk-shaped storage medium when the disk-shaped storage medium is accommodated in the concave portion of the base plate.

13. A spindle motor unit comprising:
the base plate according to claim 10;
a stator accommodated in the concave portion of the base plate; and
a rotor including a rotor magnet opposed to the stator.

14. A disk drive including a disk-shaped storage medium capable of storing information therein, comprising:
the spindle motor unit according to claim 13 rotating the disk-shaped storage medium;
a head carrying out at least one of writing and reading of information on/from the disk-shaped storage medium; and
a head moving unit moving the head relative to the disk-shaped storage medium and the spindle motor.

15. The manufacturing method according to claim 1, wherein the cutting of the portion of the work-in-process piece is carried out to remove a raised portion formed at the portion of the work-in-process piece due to wear of the mold.

16. The manufacturing method according to claim 2, wherein the cutting of the portion of the work-in-process piece is carried out until a distance in a direction perpendicular to the bottom face from the sealing plane of the work-in-process piece to a corner, formed by the cutting, at which the bottom face and the wall are connected to each other reaches a predetermined distance.
